(19) United States
(12) Patent Application Publication
(10) Pub. No.: US 2024/0208382 A1
(43) Pub. Date: Jun. 27, 2024

(54) SEAT

(71) Applicant: TOYOTA BOSHOKU KABUSHIKI KAISHA, Aichi-ken (JP)

(72) Inventors: Hansub SHIN, Aichi-ken (JP); Mitsutoshi NAKAJIRI, Gifu-ken (JP); Yuki FUKUNAGA, Aichi-ken (JP)

(73) Assignee: TOYOTA BOSHOKU KABUSHIKI KAISHA, Aichi-ken (JP)

(21) Appl. No.: 18/543,592

(22) Filed: Dec. 18, 2023

(30) Foreign Application Priority Data
Dec. 23, 2022 (JP) 2022-206420

(51) Int. Cl. B60N 2/56; B60N 2/42

(52) U.S. Cl. CPC B60N 2/5664; B60N 2/42

(57) ABSTRACT

There is provided a seat including: a seat shell that supports a seated person; and a cushion body for cushioning, provided on a seating surface of the seat shell. The seat shell includes an opening penetrating the seating surface. The cushion body includes a ventilation portion whose front surface has a ventilation property and a low-ventilation portion whose front surface has an inferior ventilation property than the ventilation portion, the ventilation portion and the low-ventilation portion being arranged side by side along the seating surface. The ventilation portion and the opening are provided side by side along the seating surface without the low-ventilation portion interposed between the ventilation portion and the opening.

### CROSS-REFERENCE TO RELATED APPLICATIONS

This application is based on and claims priority under 35 USC 119 from Japanese Patent Application No. 2022-206420 filed on Dec. 23, 2022, the contents of which are incorporated herein by reference.

### TECHNICAL FIELD

The present disclosure relates to a seat. Specifically, the present disclosure relates to a seat that includes a seat shell supporting a seated person and a cushion body for cushioning provided on a seating surface of the seat shell.

### BACKGROUND ART

JP2015-174529A discloses a bucket seat in which a cushion body for cushioning is stretched on a seat shell that supports a seated person. In such a bucket seat, a high-friction type material is used for a cover of a cushion body in order to improve a seated-person holding property.

In the configuration described in JP2015-174529A, there is a problem that the seated-person holding property is improved, but heat is likely to be accumulated and sweat is likely to be caused. Therefore, the present disclosure provides a seat of which a ventilation property can be appropriately improved.

### SUMMARY OF INVENTION

According to a first aspect of the present disclosure, a seat includes: a seat shell that supports a seated person; and a cushion body for cushioning, provided on a seating surface of the seat shell. The seat shell includes an opening penetrating the seating surface. The cushion body includes a ventilation portion whose front surface has a ventilation property and a low-ventilation portion whose front surface has an inferior ventilation property than the ventilation portion, the ventilation portion and the low-ventilation portion being arranged side by side along the seating surface. The ventilation portion and the opening are provided side by side along the seating surface without the low-ventilation portion interposed between the ventilation portion and the opening.

According to the first aspect of the present disclosure, since the cushion body includes the ventilation portion and the low-ventilation portion, it is possible to easily secure a holding property and a ventilation property compared to a case where the cushion body includes only the ventilation portion. Further, by arranging the ventilation portion side by side with the opening such that the low-ventilation portion is not interposed therebetween, the ventilation property of the ventilation portion can be appropriately improved.

According to a second aspect of the present disclosure, in the first aspect, the seat shell includes a top plate that forms a central portion of the seating surface in a seat width direction, and both banks that rise in a direction intersecting with the top plate from both sides of the top plate and form both side portions of the seating surface in the seat width direction. The cushion body has a top plate cushion provided on the top plate and both bank cushions provided on the both banks. The opening portion is formed between the top plate cushion and the both bank cushions.

According to the second aspect of the disclosure, the opening can be provided so as not to impair the sitting comfort at the time of seating. Further, the opening can be provided so as to be less likely to be blocked by a seated person.

According to a third aspect of the present disclosure, in the second aspect, the cushion body includes a linear gap that exposes the seating surface of the seat shell, along a boundary between the top plate cushion and the both bank cushions. The opening communicates with the gap.

According to the third aspect of the disclosure, since the opening and the gap of the cushion body communicate with each other, it is possible to appropriately improve the ventilation property of the ventilation portion disposed side by side with the opening, the portion of the gap, and the ventilation portion disposed side by side with the gap.

According to a fourth aspect of the present disclosure, in the second or third aspect, the top plate cushion includes a lower region configured to support a waist of the seated person and an upper region configured to support a chest of the seated person. The ventilation portion is disposed to extend across the lower region and the upper region. The opening is provided on both sides of the lower region.

According to the fourth aspect of the present disclosure, air can be exchanged between the ventilation portion extending across the lower region and the upper region of the top plate cushion and the openings provided on both sides of the lower region. Accordingly, the ventilation property of the ventilation portion can be improved over a wide range in a height direction.

According to a fifth aspect of the present disclosure, in the second or third aspect, the top plate cushion includes a lower region configured to support a waist of the seated person and an upper region configured to support a chest of the seated person. The ventilation portion is disposed in a greater proportion than the low-ventilation portion within the lower region, and the low-ventilation portion is disposed in a greater proportion than the ventilation portion within the upper region.

According to the fifth aspect of the present disclosure, it is possible to appropriately improve the ventilation property of the lower region of the top plate cushion where heat is likely to be accumulated and sweat is likely to be caused. Furthermore, in the low-ventilation portion provided in the upper region of the top plate cushion, it is possible to easily improve sitting comfort other than ventilation property by increasing surface friction.

According to a sixth aspect of the present disclosure, in the second or third aspect, the ventilation portion is each disposed in the top plate cushion and the both bank cushions.

According to the sixth aspect of the present disclosure, it is possible to appropriately improve the ventilation property of the both bank cushions in addition to the top plate cushion.

According to a seventh aspect of the present disclosure, in the any one of the first to third aspects, the cushion body includes a pad member and a cover member that wraps up the pad member, and the cover member of the ventilation portion has a superior ventilation property than the cover member of the low-ventilation portion.

According to the seventh aspect of the present disclosure, it is possible to change the ventilation property without sacrificing a cushioning property, by a simple configuration in which the cover member having different ventilation properties is used for the ventilation portion and the low-ventilation portion.

According to an eighth aspect of the present disclosure, in the any one of the first to third aspects, a surface friction of the low-ventilation portion is higher than a surface friction of the ventilation portion.

According to the eighth aspect of the present disclosure, it is possible to improve the holding property for the seated person at the low-ventilation portion. Accordingly, it is possible to secure both a holding property and a ventilation property at the time of seating.

According to a ninth aspect of the present disclosure, in the first aspect, the opening penetrates the seating surface of the seat shell in a front-rear direction.

According to a tenth aspect of the present disclosure, in the first aspect, a vertical length of the opening is greater than a lateral length of the opening.

According to an eleventh aspect of the present disclosure, in the second aspect, the top plate cushion covers a part of the opening on an inner side in the seat width direction.

According to a twelfth aspect of the present disclosure, in the third aspect, the gap of the cushion body extends over a height direction of a backrest portion of the seat, and the opening communicating with the gap is disposed above the gap.

### BRIEF DESCRIPTION OF DRAWINGS

FIG. 1 is a perspective view illustrating a schematic configuration of a seat according to a first embodiment.

FIG. 2 is a perspective view of the seat viewed from a front direction orthogonal to a torso line.

FIG. 3 is a plan view of the seat.

FIG. 4 is a rear view of the seat.

FIG. 5 is a side view of the seat.

FIG. 6 is a cross-sectional view taken along a line VI-VI in FIG. 2.

FIG. 7 is a cross-sectional view taken along a line VII-VII in FIG. 2.

### DESCRIPTION OF EMBODIMENTS

Hereinafter, embodiments of the present disclosure will be described with reference to the drawings.

### First Embodiment

### Schematic Configuration of Seat 1

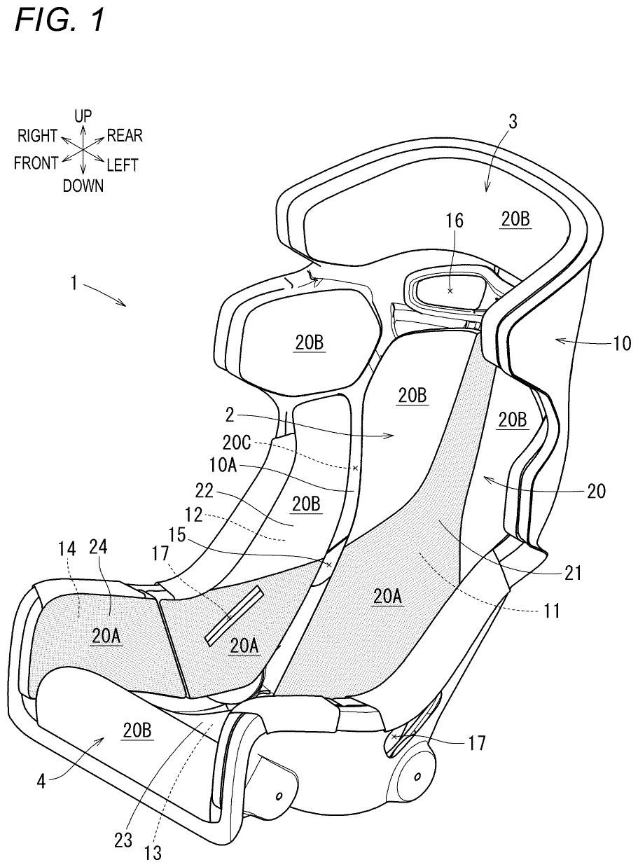

First, a configuration of a seat 1 according to a first embodiment of the present disclosure will be described with reference to FIGS. 1 to 7. In the following description, when a direction such as front, rear, up, down, left, or right is described, it is assumed that the direction indicates a corresponding direction shown in the drawings. When a “seat width direction” is described, it is assumed that the “seat width direction” refers to a left-right direction of the seat 1 described later. In addition, in the following description, when a specific reference diagram is not described or when there is no reference numeral corresponding to the reference diagram, any one of FIGS. 1 to 7 is referred to as appropriate.

As illustrated in FIGS. 1 to 5, the seat 1 according to the present embodiment is implemented as a so-called full bucket one-person seat suitable for use in racing cars and sports cars. The seat 1 is formed in a recessed curved surface shape capable of supporting a seated person in a manner of wrapping the seated person from a back side, in which a backrest portion 2, a head rest portion 3, and a seating portion 4 are provided in a continuous stretch.

Specifically, as illustrated in FIGS. 1 to 3, the seat 1 includes a seat shell 10 for supporting a seated person and a cushion body 20 for cushioning provided on a seating surface 10A that is a front surface of the seat shell 10, and is formed in a symmetrical shape. The seat shell 10 is made of carbon fiber reinforced plastic, and is formed in a recessed curved surface shape capable of supporting a seated person in a manner of wrapping the seated person from the back side.

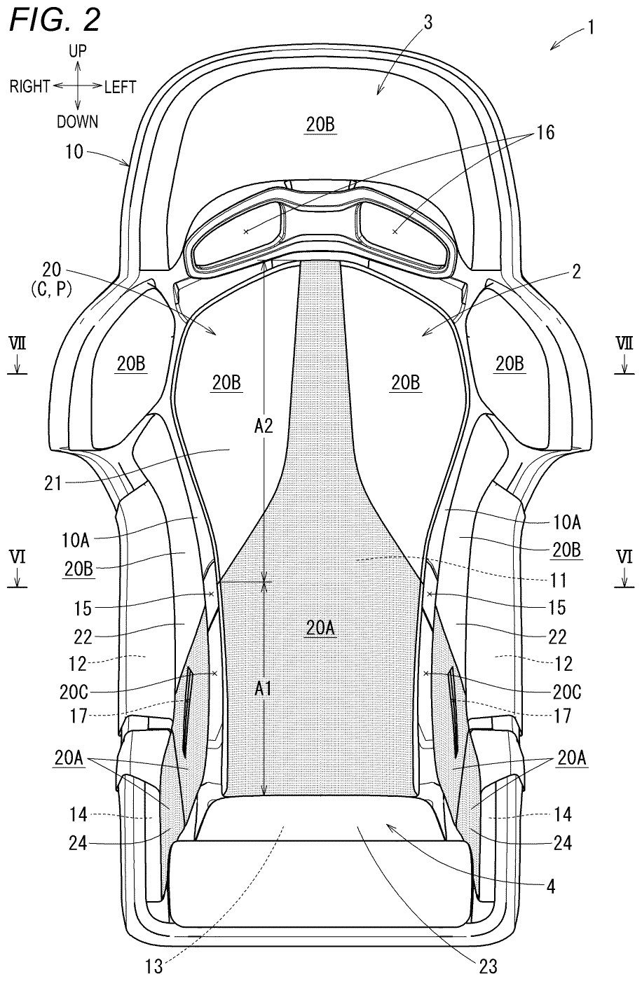

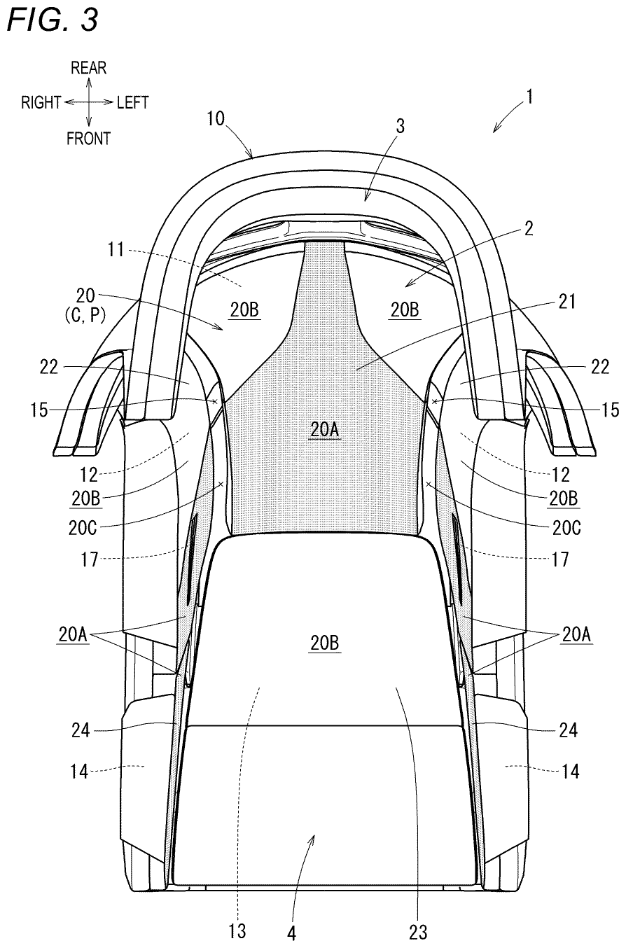

More specifically, as illustrated in FIGS. 2 and 3, a portion constituting the backrest 2 of the seat shell 10 includes a backrest top plate 11 that supports a body portion of a seated person from the rear side (back side) and a pair of left and right backrest banks 12 that support the body portion of the seated person from both left and right sides. The portion is formed in a recessed curved surface shape. The backrest top plate 11 forms a central portion in the seat width direction of the seating surface 10A that is the front surface of the seat shell 10.

Further, the backrest banks 12 rise forward (in a direction perpendicular to a surface of the backrest top plate 11) from both left and right sides of the backrest top plate 11, respectively, and form both side portions in the seat width direction of the seating surface 10A that is the front surface of the seat shell 10, respectively. Here, the backrest top plate 11 corresponds to a “top plate” of the present disclosure. Each of the backrest banks 12 corresponds to a “bank” of the present disclosure.

In addition, a portion constituting the seating portion 4 of the seat shell 10 includes a seating top plate 13 that supports hips and thighs of a seated person from a lower side (back side) and a pair of left and right seating banks 14 that support the hips and the thighs of the seated person from both left and right sides. The portion is formed in a recessed curved surface shape. The seating top plate 13 forms a central portion in the seat width direction of the seating surface 10A that is the front surface of the seat shell 10. Further, the seating banks 14 rise upward (in a direction perpendicular to a surface of the seating top plate 13) from both left and right sides of the seating top plate 13, respectively, and form both side portions in the seat width direction of the seating surface 10A that is the front surface of the seat shell 10, respectively.

As illustrated in FIG. 2, a portion constituting the head rest 3 of the seat shell 10 extends upward from the backrest 2 in a continuous manner as that in a so-called high back seat. The left backrest bank 12 and the left seating bank 14 of the seat shell 10 are formed in a continuous bank shape connected to each other in a continuous stretch. Similarly, the right backrest bank 12 and the right seating bank 14 of the seat shell 10 are formed in a continuous bank shape connected to each other in a continuous stretch.

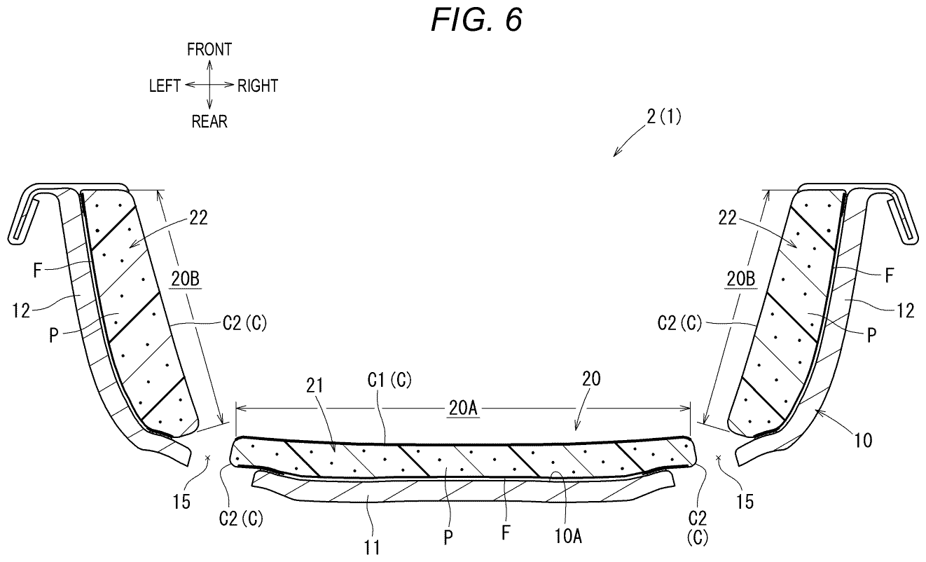

As illustrated in FIGS. 2 and 6, openings 15 penetrating the seating surface 10A in a front-rear direction are formed in a boundary portion between the backrest top plate 11 and the backrest banks 12 of the seat shell 10. Each of the openings 15 serves as a vent through which a current of air distributed from the back side to the backrest 2 is discharged to the front from the seating surface 10A. Since the seat 1 has an air conditioning function achieved through the openings 15, a ventilation property of a portion where heat is likely to be accumulated at the time of seating is appropriately improved, and sitting comfort can be obtained.

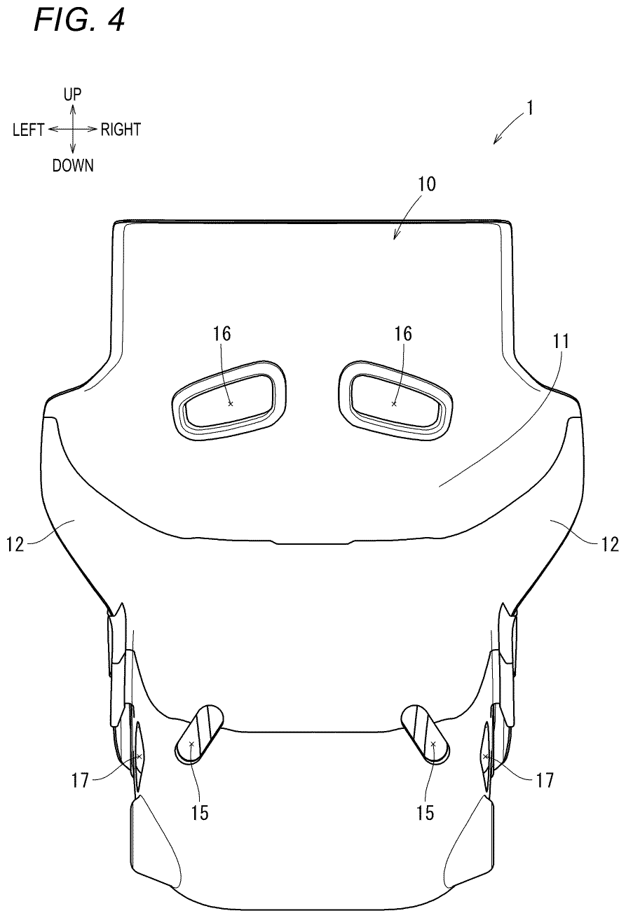

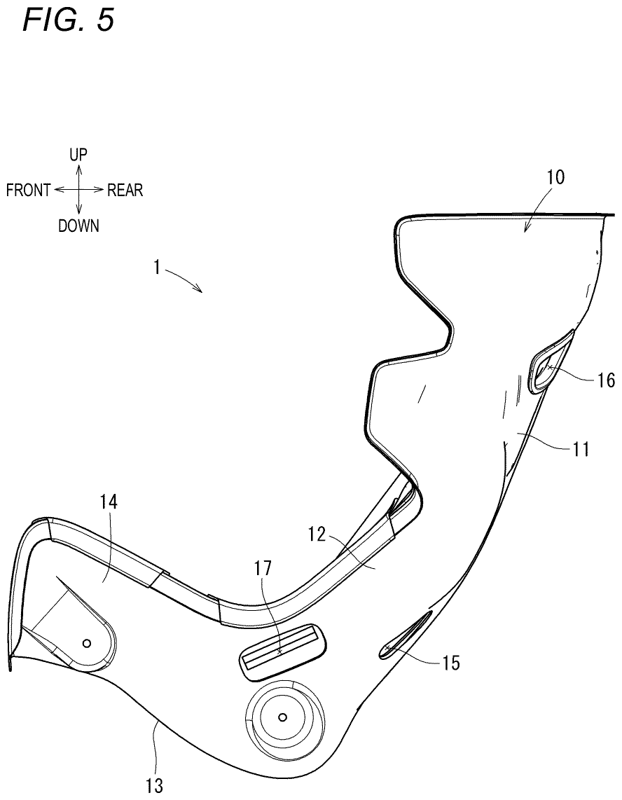

As illustrated in FIG. 2, in a boundary portion between the backrest top plate 11 and the head rest 3 of the seat shell 10, a pair of left and right upper belt insertion openings 16 are formed that penetrate the seating surface 10A in the front-rear direction and have a laterally long shape (see FIG. 4). Further, as illustrated in FIG. 5, in each seating bank 14 of the seat shell 10, a lower belt insertion opening 17 having a long hole shape penetrating the seating surface 10A in the left-right direction is formed.

Each of the upper belt insertion openings 16 and the lower belt insertion openings 17 is an insertion opening for inserting corresponding belt webbing of a five-point seat belt device (not shown). Although not shown in the drawings, the seating top plate 13 of the seat shell 10 is also formed with an insertion opening for inserting belt webbing on a crotch side, which is passed between thighs of a seated person.

As illustrated in FIGS. 2 and 3, the cushion body 20 is provided in a dispersed manner in a floating island shape at various parts on the seating surface 10A of the seat shell 10. Specifically, the cushion body 20 is separately provided at a position on the backrest 2 of the seat shell 10, a position on the head rest 3, and a position on the seating portion 4.

Specifically, the cushion body 20 is provided on the backrest 2 of the seat shell 10 so as to be divided into a backrest top plate cushion 21 that is provided on the backrest top plate 11 and backrest bank cushions 22 that are provided on the backrest banks 12, respectively. Further, the cushion body 20 is provided on the seating portion 4 of the seat shell 10 so as to be divided into a seating top plate cushion 23 that is provided on the seating top plate 13 and seating bank cushions 24 that are provided on the seating banks 14, respectively.

The backrest top plate cushion 21 corresponds to a “top plate cushion” of the present disclosure. Each of the backrest bank cushion 22 corresponds to a “bank cushion” of the present disclosure.

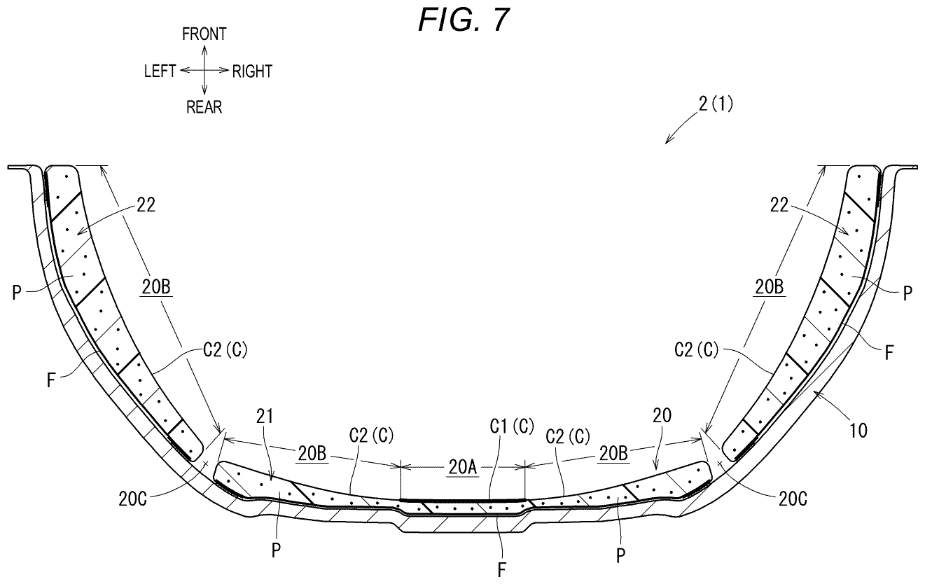

Each divided part of the cushion body 20 includes a pad member P made of urethane foam and a cover member C wrapping up the pad member P. As illustrated in FIGS. 6 and 7, the cover member C covers the pad member P from a front surface side, and peripheral edge ends of the cover member C are extended to the back side of the pad member P and are joined to a back cloth F overlapped on the back side of the pad member P with a hook-and-loop fastener (not shown), whereby the cover member C is stretched wrapping up the pad member P.

Each divided part of the cushion body 20 is detachably joined to the corresponding seating surface 10A of the seat shell 10 by a separate hook-and-loop fastener (not shown). As described, since each divided part of the cushion body 20 can be individually attached to and detached from the seat shell 10, a cushion body having a cushion thickness and a cushion shape suitable for the physique of the seated person can be appropriately and selectively applied.

The cushion body 20 includes a portion (ventilation portion 20A) in which the cover member C is implemented by a ventilation cover C1 having an excellent ventilation property, and a portion (low-ventilation portion 20B) implemented by a friction cover C2 having high surface friction. Accordingly, surface characteristics vary depending on regions. The entire ventilation cover C1 is made of a polyester 3D mesh material having an excellent ventilation property. The entire friction cover C2 is made of BRIN⋅NAUB (registered trademark) having high surface friction. By using the 3D mesh material for the ventilation cover C1, heat accumulated within the ventilation cover C1 is easily discharged to the outside.

As illustrated in FIG. 2, a portion of the cushion body 20 provided in the head rest 3 is implemented by the low-ventilation portion 20B having high surface friction. Further, as illustrated in FIG. 3, the seating top plate cushion 23 of the cushion body 20 is also implemented by the low-ventilation portion 20B having high surface friction.

On the other hand, as illustrated in FIG. 2, the backrest top plate cushion 21 is implemented by both the ventilation portion 20A and the low-ventilation portion 20B. Specifically, the backrest top plate cushion 21 includes a lower region A1 supporting the waist of a seated person and an upper region A2 supporting the chest of the seated person. Regarding the backrest top plate cushion 21, the upper region A2 has a shape of gradually widening upward from the lower region A1.

In the lower region A1 of the backrest top plate cushion 21, an entire region of a front surface thereof in a height direction is implemented by the ventilation portion 20A. Further, in the upper region A2 of the backrest top plate cushion 21, a front surface of a central portion in the seat width direction is implemented by the ventilation portion 20A over an entire region in the height direction, and front surfaces of both side portions in the seat width direction are implemented by the low-ventilation portion 20B over an entire region in the height direction that has high surface friction.

Regarding the ventilation portion 20A formed in the central portion of the upper region A2 of the backrest top plate cushion 21, a region on a lower side of a substantial center in the height direction has a triangular shape of gradually widening downward, and a lower edge thereof is connected to an upper edge of the ventilation portion 20A of the lower region A1 over an entire region in a width direction. Regarding the ventilation portion 20A formed in the central portion of the upper region A2, a region on an upper side of the substantial center in the height direction has a band shape of extending straight upward with a substantially constant width.

The openings 15 formed in the seat shell 10 are formed so as to be located on both left and right sides of an upper end portion in the lower region A1 of the backrest top plate cushion 21. Accordingly, in the backrest top plate cushion 21, the ventilation portion 20A constituting the lower region A1 is disposed adjacent to the openings 15.

In the backrest top plate cushion 21, a peripheral edge portion of the cover member C covering peripheral side surfaces of the pad member P is implemented by the friction cover C2 (see FIG. 7) over the majority thereof. However, the cover member C that covers an entire lower side surface and a central portion of an upper side surface (a region facing the ventilation cover C1) of the backrest top plate cushion 21 is implemented by the ventilation cover C1. In addition, all the peripheral edge ends of the cover member C, which are extended to the back side of the pad member P, are formed by the friction cover C2.

Further, as illustrated in FIG. 1, each backrest bank cushion 22 of the cushion body 20 is implemented by both the ventilation portion 20A and the low-ventilation portion 20B having high surface friction. Specifically, a region of each of the backrest bank cushions 22, which is disposed side by side with the upper region A2 of the backrest top plate cushion 21 at the same height, is implemented by the low-ventilation portion 20B having high surface friction. Further, a region of each backrest bank cushion 22, which is disposed side by side with the lower region A1 of the backrest top plate cushion 21 at the same height, is implemented by the ventilation portion 20A.

Further, each seating bank cushion 24 of the cushion body 20 is implemented by the ventilation portion 20A. Accordingly, the ventilation portion 20A of each backrest bank cushion 22 and the ventilation portion 20A of each seating bank cushion 24 are arranged side by side in the front-rear direction.

As illustrated in FIG. 2, the backrest top plate cushion 21 and the backrest bank cushions 22 are disposed in a state of being spaced apart from each other along shapes of both side edges of the backrest top plate cushion 21. Accordingly, a linear gap 20C at which the seating surface 10A of the seat shell 10 is exposed is formed between the backrest top plate cushion 21 and each backrest bank cushion 22 along the corresponding side edge.

The openings 15 formed in the seat shell 10 are formed in regions where the gaps 20C are formed. Accordingly, each opening 15 is in communication with the corresponding gap 20C. With such a configuration, in the seat 1, when the current of air is distributed from the back side to the openings 15, the current of air passing the openings 15 is passed through the gaps 20C over a wide range in the height direction of the backrest 2.

In addition, the current of air easily passes through the ventilation portions 20A of the cushion body 20 facing the openings 15 and the gaps 20C, and the ventilation property of the ventilation portions 20A is appropriately improved. Specifically, the ventilation portion 20A is formed over an entire region in the width direction and the height direction of the lower region A1 of the backrest top plate cushion 21, and extends in a tapered shape from the lower region A1 to a central portion of an upper end of the upper region A2. Therefore, a wide flow of air easily reaches an upper position along the central portion of the upper region A2, from the lower region A1 of the backrest top plate cushion 21 facing the openings 15 and the gaps 20C, and it is expected that the ventilation property of the entire ventilation portion 20A is appropriately improved.

In addition, the ventilation portion 20A is also formed in each backrest bank cushion 22 and each seating bank cushion 24 that is arranged in front of the corresponding backrest bank cushion 22 side by side. Therefore, a wide flow of air easily reaches each seating bank cushion 24 from a region of the corresponding backrest bank cushion 22 facing the corresponding opening portion 15 and gap 20C, and it is also expected that the ventilation property of the entire ventilation portion 20A is appropriately improved.

More specifically, the openings 15 and the gaps 20C communicating with the openings 15 correspondingly are provided so as to face the lower region A1 of the backrest top plate cushion 21 that supports the waist and at which heat is likely to be accumulated and sweat is likely to be caused. Therefore, it is possible to effectively improve the ventilation property of parts where heat is likely to be accumulated as described above. In addition, since the ventilation portion 20A extends upward along the central portion of the upper region A2 from the lower region A1 of the backrest top plate cushion 21, it is possible to appropriately improve the ventilation property of the region along a central portion of the back of the seated person where sweat is likely to be caused.

As illustrated in FIG. 6, the backrest top plate cushion 21 is provided so as to protrude to cover, from the front, a part of each opening 15 on an inner side in the seat width direction with respect to each opening 15 of the seat shell 10. Accordingly, even when the openings 15 are formed, the backrest top plate cushion 21 is ensured to be wide, and the sitting comfort can be obtained. In addition, since an opening width of each opening 15 is narrowed by the protrusion of the backrest top plate cushion 21, a speed of the current of air passing through each opening 15 is expected to be increased correspondingly, and the ventilation property is expected to be appropriately improved.

As illustrated in FIG. 2, both side portions of the upper region A2 of the backrest top plate cushion 21 in the seat width direction are formed of the low-ventilation portions 20B having high surface friction. These portions are portions that support shoulder blades of the seated person and thus receive a relatively high body pressure. Therefore, it is expected that swaying of the seated person during vehicle traveling can be appropriately suppressed by the low-ventilation portions 20B.

The region of each of the backrest bank cushions 22, which is disposed side by side with the upper region A2 of the backrest top plate cushion 21 at the same height, is implemented by the low-ventilation portion 20B having high surface friction. These portions are portions that support, from both outer sides, both arms of the seated person that are stretched forward when the seated person operates a steering wheel of an automobile. Therefore, it is expected that movement in which the body of the seated person leans forward at the time of deceleration of the vehicle can be appropriately suppressed by the backrest bank cushions 22.

As illustrated in FIG. 3, the entire seating top plate cushion 23 is formed of the low-ventilation portion 20B having high surface friction. The seating top plate cushion 23 is a portion that supports the hips and thighs of the seated person and thus receives a relatively high body pressure. Therefore, it is expected that the body of the seated person can be appropriately prevented from slipping forward at the time of sudden deceleration or front collision of the vehicle by the seating top plate cushion 23.

In summary; the seat 1 according to the present embodiment has the following configuration. In the following description, reference numerals assigned in parentheses correspond to the configurations described in the above embodiment.

That is, a seat (1) includes a seat shell (10) for supporting a seated person and a cushion body (20) for cushioning, provided on a seating surface (10A) of the seat shell (10). The seat shell (10) includes an opening (15) penetrating the seating surface (10A). The cushion body (20) includes a ventilation portion (20A) whose front surface has a ventilation property and a low-ventilation portion (20B) whose front surface has an inferior ventilation property than the ventilation portion (20A), the ventilation portion and the low-ventilation portion being arranged side by side along the seating surface (10A). The ventilation portion (20A) and the opening (15) are provided side by side along the seating surface (10A) without the low-ventilation portion (20B) interposed therebetween.

As described above, since the cushion body (20) includes the ventilation portion (20A) and the low-ventilation portion (20B), it is easy to secure a holding property and a ventilation property at the time of seating compared to a case where the cushion body (20) includes only the ventilation portion (20A). Further, by arranging the ventilation portion (20A) side by side with the opening (15) such that the low-ventilation portion (20B) is not interposed therebetween, the ventilation property of the ventilation portion (20A) can be appropriately improved.

Further, the seat shell (10) includes a top plate (11) that forms a central portion of the seating surface (10A) in a seat width direction, and both banks (12) that rise in a direction intersecting with the top plate (11) from both sides of the top plate (11) and form both side portions of the seating surface (10A) in the seat width direction. The cushion body (20) is divided into a top plate cushion (21) provided on the top plate (11) and both bank cushions (22) provided on the both banks (12). The opening (15) is formed between the top plate cushion (21) and the both bank cushions (22). According to the above configuration, the opening (15) can be provided so as not to impair the sitting comfort at the time of seating. Further, the opening (15) can be provided so as to be less likely to be blocked by a seated person.

Further, the cushion body (20) includes a linear gap (20C) that exposes the seating surface (10A) of the seat shell (10), along a boundary between the top plate cushion (21) and the both bank cushions (22). The opening (15) communicates with the gap (20C). According to the above configuration, since the opening (15) and the gap (20C) of the cushion body (20) communicate with each other, it is possible to appropriately improve the ventilation property of the ventilation portion (20A) disposed side by side with the opening (15), the portion of the gap (20C), and the ventilation portion (20A) disposed side by side with the gap (20C).

Further, the top plate cushion (21) includes a lower region (A1) configured to support the waist of the seated person and an upper region (A2) configured to support the chest of the seated person. The ventilation portion (20A) is disposed in a manner of extending across the lower region (A1) and the upper region (A2). The opening (15) is provided on both sides of the lower region (A1). According to the above configuration, air can be exchanged between the ventilation portion (20A) extending across the lower region (A1) and the upper region (A2) of the top plate cushion (21) and the openings (15) provided on both sides of the lower region (A1). Accordingly; the ventilation property of the ventilation portion (20A) can be improved over a wide range in a height direction.

Further, the ventilation portion (20A) is disposed in a majority of the lower region (A1), and the low-ventilation portion (20B) is disposed in a majority of the upper region (A2). According to the above configuration, it is possible to appropriately improve the ventilation property of the lower region (A1) of the top plate cushion (21) where heat is likely to be accumulated and sweat is likely to be caused. Furthermore, in the low-ventilation portion (20B) provided in the upper region (A2) of the top plate cushion (21), it is possible to easily improve sitting comfort other than a ventilation property by increasing surface friction.

In addition, the ventilation portion (20A) is each disposed in the top plate cushion (21) and the both bank cushions (22). According to the above configuration, it is possible to appropriately improve the ventilation property of the both bank cushions (22) in addition to the top plate cushion (21).

The cushion body (20) includes a pad member (P) and a cover member (C) that wraps up the pad member (P). The cover member (C) of the ventilation portion (20A) has a superior ventilation property than the cover member (C) of the low-ventilation portion (20B). According to the above configuration, the ventilation property can be changed without sacrificing a cushioning property, by a simple configuration in which the cover member (C) having different ventilation properties is used for the ventilation portion (20A) and the low-ventilation portion (20B).

The low-ventilation portion (20B) has higher surface friction than the ventilation portion (20A). According to the above configuration, it is possible to improve the holding property for the seated person at the low-ventilation portion (20B). Accordingly, it is possible to secure both a holding property and a ventilation property at the time of seating.

### OTHER EMBODIMENTS

Although the embodiment of the present disclosure has been described above with reference to one embodiment, the present disclosure can be implemented in various embodiments other than the above embodiment.

### Other Embodiment 1

A seat of the present disclosure may be configured such that a seat shell is applied only to a backrest, and a seating portion supports a seated person by a seat frame that is not the seat shell. In addition to being applied as a seat used in an automobile, the seat may be applied to a vehicle other than an automobile, such as a railroad vehicle. The seat may be applied to other vehicles such as an aircraft or a ship. The seat may be applied to a so-called sports stadium seat, a gaming chair, and a racing simulator seat. The seat may be applied to a caster chair, a rocking chair, and a legless chair.

### Other Embodiment 2

The seat shell may be made of a glass fiber reinforced plastic, in addition to being made of a carbon fiber reinforced plastic. Further, the seat shell may be formed of a resin panel containing no composite fiber of glass fiber or carbon fiber.

### Other Embodiment 3

An opening formed in the seat shell may be provided at only one part, or may be provided at three or more parts. A shape of the opening is not limited to a specific shape, and may be a circular shape, an oval shape, a polygonal shape, or another irregular shape. Further, the opening may be formed at a position other than the positions described in the above embodiment, such as a position between the backrest and the seating portion, both side positions of the seating portion in the seat width direction, or a central position of the backrest or the seating portion.

### Other Embodiment 4

A ventilation property of a cushion body may be changed depending on a type of a cover member, or changed depending on presence or absence, size, or number of ventilation holes formed in a pad member. The ventilation property may be changed depending on both the type of the cover member and a mode of the ventilation hole formed in the pad member. The pad member may be formed of a cushioning material made of three-dimensionally entangled resin fibers. The cushion body may be implemented by wrapping the pad member with the cover member, or may be implemented by only a cushioning member such as the pad member without the cover member.

In addition, the cushion body may be provided in each region on the seating surface as a composite body in which a plurality of cushion bodies are densely arranged instead of a single body. In this case, the ventilation property of the cushion body may be changed depending on a density of the composite body.

The cushion body may be detachably joined to the seating surface of the seat shell by a hook-and-loop fastener, or may be joined to the seating surface of the seat shell by pulling an end of the cover member from a through hole formed in the seat shell to a back side and fixing the end. The cushion body may be joined to the seating surface of the seat shell using an adhesive, a screw, or a clip.

### Other Embodiment 5

A material of the cover member wrapping up the pad member of the cushion body is not particularly limited as long as the ventilation portion has a superior ventilation property than the low-ventilation portion. Specifically, it is possible to apply a material such as a fabric, artificial leather, real leather, or PVC leather to the cover member. Examples of the fabric include moquette, wool fabric, tricot, and BRIN⋅NAUB (registered trademark). In addition, examples of the artificial leather include Alcantara (registered trademark) and Ultrasuede (registered trademark). In addition, examples of the real leather include semi-aniline leather and premium Nappa leather.

The low-ventilation portion is not limited to a portion having surface friction higher than that of the ventilation portion, and may be a portion having surface friction equal to or lower than that of the ventilation portion. The low-ventilation portion may be harder or softer than the ventilation portion. The low-ventilation portion may include a front surface having a ventilation property, or may include a front surface having no ventilation property.

What is claimed is:

1. A seat comprising:
a seat shell that supports a seated person; and
a cushion body for cushioning, provided on a seating surface of the seat shell, wherein
the seat shell includes an opening penetrating the seating surface,
the cushion body includes a ventilation portion whose front surface has a ventilation property and a low-ventilation portion whose front surface has an inferior ventilation property than the ventilation portion, the ventilation portion and the low-ventilation portion being arranged side by side along the seating surface, and
the ventilation portion and the opening are provided side by side along the seating surface without the low-ventilation portion interposed between the ventilation portion and the opening.

2. The seat according to claim 1, wherein
the seat shell includes a top plate that forms a central portion of the seating surface in a seat width direction, and both banks that rise in a direction intersecting with the top plate from both sides of the top plate and form both side portions of the seating surface in the seat width direction,
the cushion body has a top plate cushion provided on the top plate and both bank cushions provided on the both banks, and
the opening portion is formed between the top plate cushion and the both bank cushions.

3. The seat according to claim 2, wherein
the cushion body includes a linear gap that exposes the seating surface of the seat shell, along a boundary between the top plate cushion and the both bank cushions, and
the opening communicates with the gap.

4. The seat according to claim 2, wherein
the top plate cushion includes a lower region configured to support a waist of the seated person and an upper region configured to support a chest of the seated person,
the ventilation portion is disposed to extend across the lower region and the upper region, and
the opening is provided on both sides of the lower region.

5. The seat according to claim 2, wherein
the top plate cushion includes a lower region configured to support a waist of the seated person and an upper region configured to support a chest of the seated person, and
the ventilation portion is disposed in a greater proportion than the low-ventilation portion within the lower region, and the low-ventilation portion is disposed in a greater proportion than the ventilation portion within the upper region.

6. The seat according to claim 2, wherein
the ventilation portion is each disposed in the top plate cushion and the both bank cushions.

7. The seat according to claim 1, wherein
the cushion body includes a pad member and a cover member that wraps up the pad member, and
the cover member of the ventilation portion has a superior ventilation property than the cover member of the low-ventilation portion.

8. The seat according to claim 1, wherein
a surface friction of the low-ventilation portion is higher than a surface friction of the ventilation portion.

9. The seat according to claim 1, wherein
the opening penetrates the seating surface of the seat shell in a front-rear direction.

10. The seat according to claim 1, wherein
a vertical length of the opening is greater than a lateral length of the opening.

11. The seat according to claim 2, wherein
the top plate cushion covers a part of the opening on an inner side in the seat width direction.

12. The seat according to claim 3, wherein
the gap of the cushion body extends over a height direction of a backrest portion of the seat, and
the opening communicating with the gap is disposed above the gap.
